(19) United States
(12) Patent Application Publication
(10) Pub. No.: US 2017/0024755 A1
(43) Pub. Date: Jan. 26, 2017

(54) MERIT-BASED ON-LINE ELECTIVE LOAN PAYOFF SYSTEM

(71) Applicant: Patricia Ann McNair, Bartlett, TN (US)

(72) Inventor: Patricia Ann McNair, Bartlett, TN (US)

(21) Appl. No.: 14/035,842

(22) Filed: Sep. 24, 2013

(51) Int. Cl. G06Q 30/02

(52) U.S. Cl. CPC G06Q 30/0207

(57) ABSTRACT

An on-line submission and voting system for participants to seek a collective merit-based loan payoff grant is provided. With a full subscription service including any number of members of a certain narrow (or broad) population of similarly situated individuals, the system allows for each participant to submit an essay (or other like document) for review by the population members on a monthly basis. Upon review, the members, who all contribute a certain monetary amount to the service within a set time period (such as monthly), are permitted to vote for the best overall essay (or essays) based on certain criteria. The winner or winners are then provided with proceeds from the service's fee intake specifically to provide student loan payoffs. Such a service may be correlated to geographic, industry, or any other group for such a purpose. The method of implementing and utilizing this inventive system are also encompassed herein.

### FIELD OF THE INVENTION

An on-line submission and voting system for participants to seek a collective merit-based loan payoff grant is provided. With a full subscription service including any number of members of a certain narrow (or broad) population of similarly situated individuals, the system allows for each participant to submit an essay (or other like document) for review by the population members on a monthly basis. Upon review, the members, who all contribute a certain monetary amount to the service within a set time period (such as monthly), are permitted to vote for the best overall essay (or essays) based on certain criteria. The winner or winners are then provided with proceeds from the service's fee intake specifically to provide student loan payoffs. Such a service may be correlated to geographic, industry, or any other group for such a purpose. The method of implementing and utilizing this inventive system are also encompassed herein.

### BACKGROUND OF THE INVENTION

Student loan issues have become prominent in recent years as the costs for higher education have risen to extremely high levels and the necessity for borrowed funds, whether from governmental or private sources, have consequently increased as well. Individuals seeking certain degrees from specific educational institutions have, in certain circumstances, undertaken rather high debt loads through such student loan packages, ostensibly investing in a future payoff (with hoped-for high salaries) through such degrees. As such, there have been situations wherein these individuals seek consolidation (and thus delay in payoff) of serviced loans and/or reduction or forgiveness (at least to a certain level) through volunteerism or taking employment within a certain area (geographically or industrially, such as within the education field in a rural location, for example). In such circumstances, those individuals at least have some outside contribution or debt reduction potential (as well as possibly utilizing the position to gain important work experience). The vast number of students, whether college, graduate, professional, etc., that undertake student loans, however, remain in position requiring repayment within a certain amount of time, sometimes at rates that are in excess of a relatively new employee's monthly budgetary constraints. Default on such loans is problematic since bankruptcy does not allow for such debt forgiveness, too. Basically, although the need to achieve a degree from a certain institution should help in the long run to provide greater potential for wealth generation for individuals, the initial obstacle of debt servicing soon after graduation has proven a Herculean task for many people today. As such, there exists a definite need to provide a possible means to collectively reduce individual debt levels in this respect, particularly through a merit-based system.

As of today, as alluded to above, there is very little available to student loan debtors other than debt possible reduction or restructuring services. Debt consolidation allows for a borrower to take 2 or more loans and have them amortized together over a far longer period than initially undertaken (for example, extending the payback term from 10 years from initial loan to 25 years). The overall payoff will grow exponentially under such a scenario, certainly, but the monthly payments may be easier for the borrower to handle initially. The overall costs, though, for such a system makes such an alternative undesirable for obvious reasons.

Certain programs for, as examples, overseas volunteer and/or teaching, etc., activities (Peace Corps, Americorps, etc.) allow for certain debt forgiveness (or aid) for student loans. Such programs, though, do require significant investment in time and resources prior to debt help in that respect, forcing the individual to undertake a demanding (though, arguably, rewarding) activity to obtain such a result. Even with such a potential pay down of student loan debt, however, such programs do not generally provide overall reductions, only partials. Thus, there would still be some loan servicing to undertake at a future point in time, even if such activities not only reduce loan payments, ultimately, but delay interest accrual over such time.

There are also certain programs that provide private company servicing to negotiate debt levels for possible reductions. These situations entail, generally, retention of an entity at a cost to work with student loan agencies on behalf of the borrower. Such situations, though, are typically initiated at a time when the borrower is at a drastic point and needing such outside help, even if such involves paying for such intervention (and thus, possibly incurring greater debts without any guarantee of student loan debt reduction in the process). Basically, the typical issues in this respect limit the effectiveness of such an outside source (and the involvement of another outside company on the other side seeking debt repayment initially further complicates the matters, too), leaving the borrower in a rather precarious position, sometimes worse than before.

As it now stands, then, the ability to help student loan borrowers after graduation to repay their loan debts are actually rather limited. Certainly, there exist some organizations that may help individuals upon direct request (for example, religious congregations have been known to pool resources for specific persons for such endeavors; likewise, fund-raising activities have also been undertaken for specific individuals for such purposes, too); unfortunately, such instances are very limited in scope and depend upon very limited populations of interested members to help.

There thus exists a void within this area to help individuals burdened with student loan debt (or, alternatively, any type of incurred debt, for that matter) such that a collective population may provide a means to choose a specific individual (or individuals) based on certain merits associated with the individual's (or individuals') underlying reason for incurring student loan (or other) debt. In essence, to date there is no system or process that allows for a certain group of individuals to collectively agree to and decide to help certain borrowers with their incurred student loan (or other) debt load. The closest system currently pertains to objectively chosen individuals by a corporate or government entity (for instance, debt forgiveness due to Peace Corps involvement for a certain time period) rather than a population of individuals that freely join such an organization and decide, democratically, on such a result through a subjective voting process. In that manner, the basic principles of fairness, coupled with merit-based results of the selection made by the majority of a certain freely organized population of decision-makers allows for such an entire group to feel quite comfortable in its ultimate donation of funds for such a purpose. The system may allow for multiple decisions of this type (such as monthly, quarterly, etc.), thereby further enhancing the potential for greater numbers of individuals to submit work for the population to select from, as well as permitting larger numbers of individuals to seek such a possible result, based primarily on his or her capabilities, rather than through a lottery situation. Unfortunately, to date, such a system has yet to be developed and/or implemented at all.

### Advantages and Summary of the Invention

One distinct advantage of the inventive system is the capability for an individual to subscribe to an on-line forum as both a contributor and a voter in order to compete with the entire contributor population for a merit-based payout. Another advantage of such a system is the capability of the voter population to select meritorious individuals for monetary payouts in the same on-line forum. Yet another advantage thereof is the ability to provide such payouts based upon the monetary submissions of all subscribers within a specific time frame, with the greater amount of voter and contributor pay-ins allowing for greater amounts of payouts. Still another advantage of the inventive system is the potential to divide each population set into different demographics, including geographic regions, employment groups, and the like. Yet another advantage is the capability of pooling individual education-based contributors for submission of certain documentation (creative works, such as essays, for instance, on specific topics) for selection by education-based voters for the purposes of choosing individual contributors for receipt of monetary awards for student loan payoffs (or pay downs).

Accordingly, this invention encompasses an on-line decision-making system to allow for a specific population to select winners of a merit-based competition, said system including the method steps of

1) providing a subscription service in an on-line setting, wherein said service allows for a voting population to be developed from individuals that subscribe as member voters and a contributing population developed from said voting population that further contributes creative works to said service in response to an invitation from said service;

2) having said voting population individuals subscribe through at least paying a voter subscription fee to said service for a certain time period;

3) having said service generate a certain topic for which a contributor may create a creative work in relation to said topic such that said generated topic is provided by said service for a specific period of time for action to be undertaken by a plurality of members of said contributing population;

4) allowing for submissions of said creative works by said plurality of members of said contributing population, wherein each submission is made together with a contributor submission fee, wherein said contributor subscription fee is greater in amount per individual than said voter subscription fee, and wherein said creative works are submitted by said plurality of members of said contributing population for review by said voting population individuals for the time period for which each member of said available voting population are subscribers thereto;

5) having said voting population individuals select the most meritorious creative work within said time frame in relation to said generated topic after collective review thereof, wherein the most votes cast for a single creative work is sufficient for collective selection thereof for such a purpose; and

6) having said on-line service then generate a payout to a creditor of the winner (or winners) selected by said voting population, wherein said payout is assessed in relation to a) the amount said winner (or winners) currently have as student loan debt and b) to the overall monetary amount generated by the available subscription fees for said voting population and, optionally, at least a portion of the submission fees from said plurality of members of said contributing population within the time frame during which said merit-based competition is open for contributor submissions and thus during which such competitive creation selection is made by said voting population.

Alternatively, such an inventive on-line system may include population parameters based upon the geographic location of each voting and/or contributing population individual. As well, the inventive system may also be limited to specific industrial areas, such as educational persons, in order to allow for limited populations to decide certain monetary payouts for like-situated individuals. In essence, this system, based upon computerized submissions, subscriptions, on-line tallies, and, ultimately, voting decisions and final payouts, allows for very broad populations to pool resources in an effort to allow any individual of interest in such a scenario to not only compete through the creation and submission of his or her own work, but also for like-minded individuals to adjudge and, ultimately, grant monetary payouts based upon such a submission/subscription platform.

Thus, through an entirely computerized system, any number of individuals may be reached and convinced to contribute money and creative content for the purpose of not only aiding certain individuals in need of financial help, but also for the purpose of possibly winning such a monetary award for direct student loan debt reduction and also contributing scholarly and/or artistic works, debate, and like content to the overall system population. To date, there have been certain systems that allow for an on-line entity (such as a company or service) to accept contributions for decision-making on the merits of such submissions by a company-selected group of decision makers (for instance, scholarship services are well-known to accept creative papers of different types for internal review and judging to occur; in those instances, the decision makers are very limited in number and scope and of a set pre-determined population). No system has been developed, however, that allows for subscribers to pay into the system with the proceeds feeding the payout decided by voting members of such a system of works submitted by contributors for such a vote, not to mention wherein such a voting population is not static (at least theoretically) nor limited to individuals chosen by any one entity. As well, the ability to provide such a service (or system) on a total on-line platform, not to mention, if necessary, the ability to provide the subscriptions within specific time frames (and or other limited scenarios, such as, again, geographic areas, at least) for monetary payouts based upon subscription fees received for payout within such time frames, etc., has not been disclosed previously.

Such a system may be implemented for the purpose of allowing winning contributing population individuals to receive monetary payouts for any number of items, for example, the specific payoff or pay down of student loan debts. The overall platform may be modified as needed to pertain to any type of situation, however, wherein the voting population individuals may be from any area, industry, etc., and the system is set up to reward contributing population individuals with monetary awards in relation to such area, industry, etc., as well. The key consideration is the ability for the system to have its payout proceeds derived solely from the subscription fees paid by the voting population individuals. As noted above, such payout proceeds may be limited to the voting member subscription fee collections alone or may utilize at least a portion (if not all) of the fees paid by each contributing member in association with his or her individual submission within the same time frame and in response to the generated topic by the subscription service. In essence, the payout proceeds may be adjusted in terms of the available amounts thereof in relation to the revenues generated from at least the total voting member subscription fees with any amount of the contributing members' submission fees. Preferably, the voting member fees are the sole source of payout proceeds with the contributing submission fees utilized for the underlying website/infrastructure/administrative costs of the subscription service itself. Additionally, modifications to the determination of payout proceeds may be made if the number of subscribers within a certain time period is sufficient to generate a larger amount of pooled money for merit-based awards. In such a situation, it is possible that more than one selected winner may be rewarded within that time frame. Likewise, if the geographic region exceeds a certain amount of subscription funds for such a purpose, then an increase in winners may be permitted. Additionally, if the time frame at issue shows a significant increase in funds, then the duration thereof may be curtailed to allow for another vote to be permitted to increase the number of selected winners by the voting population individuals. The key consideration is the ability to have indefinite numbers of members within the service to contribute to the overall funds pool. Thus, the voting members have a personal stake is assuring his or her monetary resources are granted to the recipient that is democratically selected by the voting population individuals. As such, the system is configured to also ensure that each member is permitted a single vote to that end. Such is described in greater detail below.

As alluded to above, without any limitation to the breadth and scope of this overall configuration, this inventive system is particularly attractive for individuals that have a rather large student loan debt level and have chosen to enter the educational field as their career. In such situations, as is well-documented, the price of a person's education may have required significant loan servicing (and thus rather large student loan debt) with a profession that is known to pay salaries that are not always conducive to permitting significant (and steady) student loan debt payments. As such, the inventive system provides a valuable avenue for those that need help in this area, as well as a means to exercise a creative and thoughtful side for submission of works to a voting population for acceptance and consideration. Such creative works, and thus the definition of the term for this invention, may be any creation developed by an individual that is related to a specific topic provided by the subscription system. Thus, a creative work may be an essay (or other like paper), a photograph, a musical composition, a pictorial or graphic piece, a play, basically anything that may be copyrighted. In that manner, as discussed above, the contributing population individuals would pay a larger fee with each creative work submission than the voting population individuals to subscribe (as noted above, to be permitted the chance to submit a creative work to the voting population, the contributor thereof must also initially be a voting member within the specific time frame for such a submission) to the service for the purpose of creative work submissions. The greater number of contributions (submissions of creative works) within any single time frame would increase the available pool of money for disbursement subsequent to the selection by the voting population individuals. Likewise, the greater number of voting individuals would also increase the pool of money for awards. With education-based populations, it is possible that all teachers, administrators, guidance counselors, therapists, maintenance workers, social workers, psychologists, etc., may subscribe for this purpose. Such populations may be limited to the entire nation, individual states, multi-state regions, even localities (such as specific ZIP codes, for instance), as is proper to allow for sufficiently large numbers of individuals to subscribe to generate the necessary monetary pool level for such purposes (for instance, to generate enough money for the winning contributor to receive proper value with a payout to make subscription/contribution actually worthwhile). The overall computerized system may thus automatically determine such specific area populations after a certain amount of time within each period.

As well, the submission to the system of each contributing population individual's specific student loan debt level would be necessary (through proper proof) in order to assess the proper amount of monetary payout in relation to the available pool of resources for such a purpose. Importantly, the system is not intended to provide any payouts to individuals for any reason other than direct student debt load purposes. As such, this proven debt level issue must be met in a strict fashion, particularly since such payouts will most likely be made directly to the student loan creditor of each selected contributor rather than to the contributor him- or her-self. Any excess payments made to such a creditor will be returned to the inventive system and not paid from the creditor to the debtor, thus any incorrect information supplied by the contributor to the system would not affect such a situation, except for the potential to bar any further submissions and/or other participation by that specific contributor. Thus, the automated system would thus include proper configurations with software code to receive all such student loan debt information from each contributing population individual within a specific time frame (such as those that provide submissions to specific topic requests) and provide a cumulative assessment of the amount maximum and minimum that the total payout would be for each specific submission time period. In other words, within each period during which topics are requested for contributions (as one example, each month of each calendar year), there will be a maximum amount of funds received from voting members as well as due to contributor submissions. Such an amount would thus be properly correlated to the maximum (and again, minimum) student loan debt holdings of each contributing member in that time frame in order to relate the available funds received to the available funds for payout upon selection by the voting members. Thus, the system itself, in addition to receiving names, information, subscription fees, submissions, and submission fees, will automatically assess such receivable and payout monetary levels to ensure the amounts involved will be both worthwhile for the contributing members (for suitable payout upon selection) as well as suitable to allow funding for the system to be utilized and implemented. Furthermore, if the number of subscriptions and/or submissions are higher than expected, such an automatic system assessment of received funds may allow for a modification of the actual number of awards granted for the time period involved (such as an increase or decrease in the number of awards or the monetary funds available for each granted award). Overall, then, the inventive system permits such changes on the fly to provide greater effectiveness and, ultimately, involvement and aid to the subscribers and contributors. Not to mention, with the potential for such loan payouts in place, and the requirement that each contributor be a voting member, the number of submissions in response to topic requests may be significantly high, thus making the overall system highly attractive to potential members in this respect.

Of further interest, then, is the potential to expand the inventive system to different population criteria, rather than a nationwide or overall industry members, as examples. For instance, in the United States, geographic regions may be predetermined for the purpose of allowing subscriptions and submissions to be undertaken, thereby limiting the voting population to such a regional basis. Likewise, the system membership may be segregated to industry types (such as, again, educational employees), even subsets thereof (such as, for instance, teachers alone, as opposed to, say, administrators, too). The system can discern such population criteria at the time the voting individuals sign up for the service (through the input of member information, for example). As well, during any time period for voting/submissions, each member may choose a specific population for such a purpose from a menu provided automatically by the on-line system. In any event, the potential for each member to join a specific population for such a purpose is also provided by the inventive system, particularly once a certain number of voting members has actually subscribed to the overall system (and thus sufficient funds and voting numbers for each possible time period and/or specific voting/contributing population has been assessed.

Additionally, in order to best ensure parity and the greatest level of voting and contributing, any individual contributor winner will be barred from winning such a competition for a set period of time thereafter but may, if for example, in the education area embodiment, such a past winner still has a certain level of existing student loan debt subsequent to such a prior payout, allow for re-submission after a shorter period of time has passed. Such a consideration depends greatly upon the monetary funds available and/or expected due to assessed numbers of subscription members within each population.

For all of these purposes, the inventive system, being automated and on-line, will ensure that the voting and contributing procedures will involve individuals that cannot subscribe more than once for either feature. An automatic number is assigned upon sign-up to the system to each and every member individual. If solely a voting member, then the number is related to the specific individual's information. If a contributing member, then the individual's student loan information (if that is the area at issue, that is; again, this student loan debt consideration is but one possible embodiment of the overall inventive system; any other type of merit-based platform may be implemented with this system) must at least be correlated to their contributor account and kept up to date by the contributing member. As a contributor, as noted previously, such an individual must also be a voting member; correlating all such information together, then, allows for the overall system to generate individual accounts for this purpose, with each account designated to that specific individual in relation to such unique information. Once this account is set up, there should be no need for the individual to seek another account as the system would easily detect any duplications of such information.

Generally, in order to provide such a desired result, a user (member) accesses a network, or other software application, from an entry point such as a main menu or starting page. In the case of the Internet, this starting page generally is referred to as a “home page” (such as via GOOGLE, YAHOO!, MSN, and the like). In this context, a “home page” is a browser compatible file or Uniform Resource Locator (URL) address, that is displayed upon initiation of the browser by a user. In other words, the home page is the starting point for a user's network browsing experience and provides users with the ability to connect to any application, from any device, over any network connection.

From that point, the user may then access the system web site through the utilization of a web address typed within a specific search area of the home page. Or, if the home page includes a search engine capability, the user may type keywords to access a web site through such a system. At any rate, through such a basic method, the user may access the desired web site, in this case, as one example, one that allows for educators (or like individuals) that are similarly situated in terms of student loan debt to access the inventive system web page to sign in, sign up, review topic requests, submit topic papers, review topic papers, and vote on the most meritorious submission for the purpose of having the system count such votes and provide a certain monetary amount from the fees submitted by the voters/contributors to the selected contributor's student loan account for pay down (if not payoff).

The system generally comprises at least one server computer as an internet connected server which supports a TCP/IP protocol and which has input and access capabilities via two-way communication lines, Ethernet capabilities, and any other like pathway. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not restriction, communication media includes wired media such as a wired network or direct wired connection (as noted above), and wireless media such as acoustic, RF, infrared and other wireless media. It will be understood and appreciated that combinations of any of the above also are included within the scope of computer readable media.

A user (member) may enter commands and information into the computer or Smartphone (or other like device) through input devices such as a keyboard and/or pointing device, commonly referred to as a mouse, trackball or touch pad. These and other input devices often are connected to the processing unit, generally through I/O Interface that is coupled to the system bus, more particularly through a port interface. As previously discussed, input devices may be connected by interface components and bus structures, such as a parallel port, game port or a universal serial bus (USB) port. A monitor or other type of display device also is connected to system bus via an interface such as I/O Interface in order to aid in viewing the website and sub-pages (as well as provide proper understanding of the icons and other indicia utilized in decorating and providing accomplishment information.

The computer (or appropriate phone technology, such as a SmartPhone) is capable of operating within the Internet to access the desired websites. Such connections may be undertaken through a local area network (LAN) and a wide area network (WAN), but may also include other networks. Such networking environments are commonplace in offices, enterprise-wide computer networks, intranets and the Internet. It will be understood and appreciated by those of skill in the art that the network connections shown are exemplary and other means of establishing a communications link between the computer, SmartPhone, or any other source, to the Internet for set-up, review, and overall control of the individual portal for such sharing of accomplishments, may be used.

Member account set up will include a number of pieces of information to ensure each individual is permitted only one vote per submission period. Thus, each voting member will necessarily supply his or her full name, address, occupation (particularly for a population that is limited to specific industry segments) with proof of such employment (such as a link to the employer for verification or even a copy of a recent pay stub, as examples), as well as the specific particulars to identify the individual's student loan account (as well as the contact information for verification of such information through the student loan creditor). Additionally, an agreement will be provided on-line for which the voting member must provide a click acceptance or e-signature indicating cooperation with the overall system requirements. Other items may also include a promise to refrain for unsavory language or other like issues within any submissions made for voting consideration if the member decides to contribute in that manner.

If the voting member thus decides to submit an essay in response to a topic request on the service site and within a specific time frame, the member will then provide further information pertaining to the submission, including, without limitation, a statement that the work is original to the contributor, is submitted within a specific time period for consideration, and the current outstanding student loan debt level of the contributor. Additionally, a separate statement will also be required of the overall system such that upon selection by the voting members within the population and time frame at issue, the winning contributor will submit confirmation of his or her student loan situation with verification from the creditor in order to further ensure payment on the contributor's behalf by the system is proper. Although the system will automatically assess the understood debt levels of all contributors for such a purpose prior to voting on submissions, this provides a failsafe mechanism to ensure the system properly pays for debt levels and nothing else. Of course, as noted above, the payments will never go directly to the winning contributors, but the avoidance of any embarrassment to the system entity in this respect is very important as well.

Sign up, submission and voting schedules may be designated to cover any time frame desired. For instance, if each submission window is to cover a monthly target, voting members will be allowed the opportunity to sign up for a specific submission time period until the window to vote has expired. As well, the system may post work topics for submission for potential contributors to review for an initial period (for instance, the first 5 days of the month). Thereafter, the site will allow contributors to click on a submission link to then provide, as one example, a 500-word typed essay (or, as described above, any type of creative work) directed to the topic at hand within a supplied submission box. Such a link will remain available for each contributor for another 10-15 days (again, as one example) during which time the contributor may save his or her work on the site and correct/update the same until the window has expired or until submission is completed. The submission is then completed through clicking the appropriate button on-line wherein the system then requests submission of the contribution fee (for instance, from $5-25) in addition to the other information discussed above, including a concise title and name listing to accompany the eventual display thereof on-line. The correlation between the voting member status and contributor status thus locks in the individual as a one-time contributor during that specific time period as well as permits a single vote in that time frame as well (a voting member may choose his or her work in this manner). Upon submission, the essay (or other creative work, such as, again, without limitation, a drawing, a photograph, a musical composition, and the like) is then held in a queue until the submission period concludes. The display and review period then commences (for 5-10 days, for example), during which each essay (or other creative work) is provided on the site and to the voting members who have paid their subscription fees for that specific time period. The display of such works may be made in any fashion, such as in relation to date of submission, as one example, and will include at least the contributor's identification number (and may include other information, including the contributor's name, the work title, and his or her place of employment). Each displayed work may be clicked by each voting member to open such links for review and consideration. The system may allow the voting members to flag individual submissions in order for the voter to refresh his or her memory prior to making a final determination as to which work merits his or her vote. Once the individual voter makes such a decision, the system allows for highlighting or other like mechanism to associate the selection thereof with the vote cast. To vote, the voting member must input his or her system identification number as well as that of the contributor for whom the voting member casts a vote. Once each voter who makes the effort to review and cast such a vote is concluded within the permitted time limit, the system then generates a vote tally and posts the results thereafter, such as between 1 hour to 12 days, preferably from 24 hours to 10 days.

As alluded to above, the overall system is configured to receive information input and collate such items into specific areas for overall assessment. Of vital importance is the ability of the system to assess the pool of monetary funds for each submission period that have been made available through voting member fees and/or contributor fees. The final assessment is made once the submission and voting sign up periods have ended within each specific time frame (monthly, bi-weekly, quarterly, etc., as examples), thus allowing the system to then provide a suitable comparison between the available funds for disbursement and the student loan debt levels of the individual contributors. If, again, the available pool is rather low, then the system properly accounts for that consideration and will either set a suitable payout for winning selections or may actually increase the submission and voting period expiration dates to allow for more funds to be collected for such a purpose. If the pool is higher than expected, the disbursements may be increased for an individual winner or multiple winners may be permitted for payouts to be provided. Certainly, the system will advertise these issues to the members thereof in an effort to garner greater participation.

Generally speaking, then, the inventive system provides a heretofore unknown manner of allowing multiple participants from different geographic areas and the like to help provide not only scholarly contributions on different topics for broad consideration, but also use such a methodology to provide a beneficial monetary payout system to help such contributors to potentially alleviate student loan debt simultaneously.

### BRIEF DESCRIPTION OF THE DRAWINGS

FIG. 1 provides a flow chart showing the utilization of the inventive method for a specific student loan payment disbursement system utilizing the contributor/voter platform.

FIG. 2 depicts a flow chart showing utilization of the inventive method of FIG. 1 but within a specific geographic region.

FIG. 3 depicts a flow chart showing utilization of the inventive method of FIG. 1 but within a specific time frame.

FIG. 4 shows a flow chart showing utilization of the inventive method of FIG. 1 showing an automatic assessment of total subscription funds within a specific time frame with maximum individual student loan payoff levels of contributing members within the same time frame for total funds disbursement availability.

### DETAILED DESCRIPTION OF THE DRAWINGS AND PREFERRED EMBODIMENTS

As would be well understood by the person of ordinary skill within this art, the drawings presented herein are not intended in any way to place limitations on the breadth and scope of the claimed invention, but are specifically provided in a manner to best explain certain embodiments that are encompassed within the inventive system itself. As such, these drawings are, again, merely presented to meet certain written description requirements and are not to be considered limiting in any manner of the invention described herein.

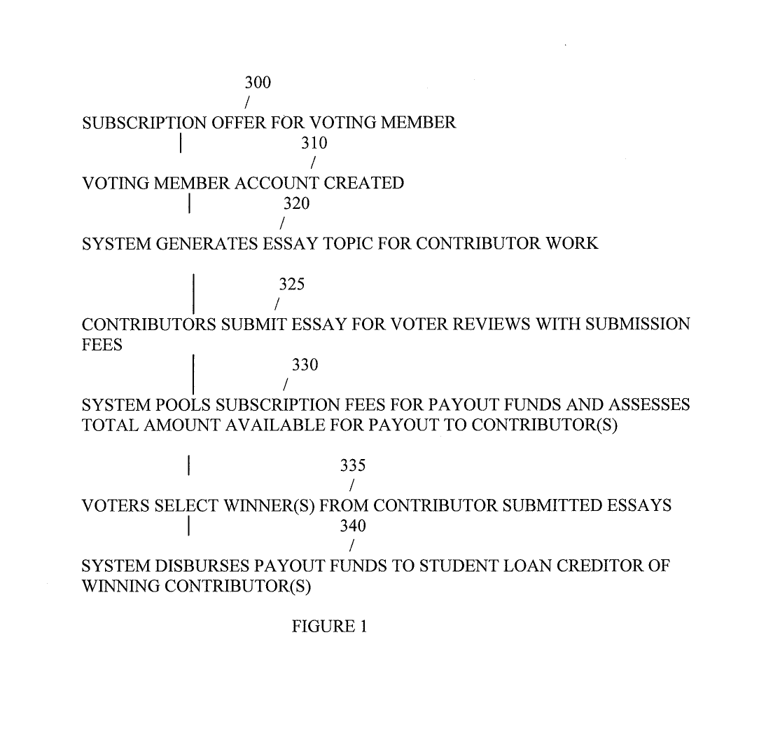

FIG. 1 presents a flow chart for a broadly based voting/contributor framework in relation to the inventive system. In accordance with the on-line configurations described above, the system is provided in such a format as a base consideration, with a user, being a voting member, or a prospective voting member, as the case may be, may access the specific website through such typical channels. The system/on-line site would thus provide a subscription offer 300 to a prospective member. In this respect, if exercised, the prospective member thus indicates acceptance thereof, completes an information display, and submits the proper subscription fee (through credit card, on-line payment service, etc., as is well known in this industry). Thereafter, the member is then considered a Voting Member and his or her account is created 310. Within the timeframe at issue, then, the system will supply a generated essay topic 320 for the collection of voting members to decide whether or not to create his or her own responsive creative work (in this case, an essay; as noted previously, such a topic or other type of base consideration, may invite any type of creative work for review and judging by the voting members). Upon creation and submission thereof 325, the voting member becomes a contributing member (while still retaining the capacity and ability to vote during the timeframe at issue), providing an uploaded (or other manner of submission) copy of his or her work, a submission fee, and outstanding student loan indebtedness information (creditor name and address, total amount owed, etc.). Such information may also be submitted to the system upon creation of the voting member account 310, with voting members not having requirement of any student loan balances, and thus the ability to denote such a situation. In either alternative, the system receives such student loan information and verifies the same prior to creation of the voting and/or contributing member status. The only concern in that manner is that such a voting member is disqualified from competing within the creative work submission contest since any payout for such an individual would be nothing as the proceeds are to be paid directly to the student loan creditor on behalf of the contributing member. Such payout proceeds are then calculated from the pooled voting member subscription fees for that time frame 330. The system itself may allow for voting members to pay a single subscription fee for a certain time frame (each year, for instance), with such fee levels assessed to appropriate amounts to fund adequate payouts. Alternatively, as noted above, such voting member subscriptions may be for the time frame of each creative work submission period, thus allowing for the potential of relatively small fees to accrue within shorter time periods to allow for not only larger payout possibilities, but also the potential for greater numbers of competitions with consequent larger numbers of varied submissions on differing topics, as well. The system thus provides the calculated payout amount(s) for the time period at issue 330 and the voting members then cast their individual votes for contributor creative work submissions (here, an essay, related to the generated topic 320) 335. The selected winner(s) then receive notification of their selection in this respect and the system then disburses payout proceeds to the winner(s) student loan creditor for an amount determined by the payout proceed level from the pooled subscription fees 340.

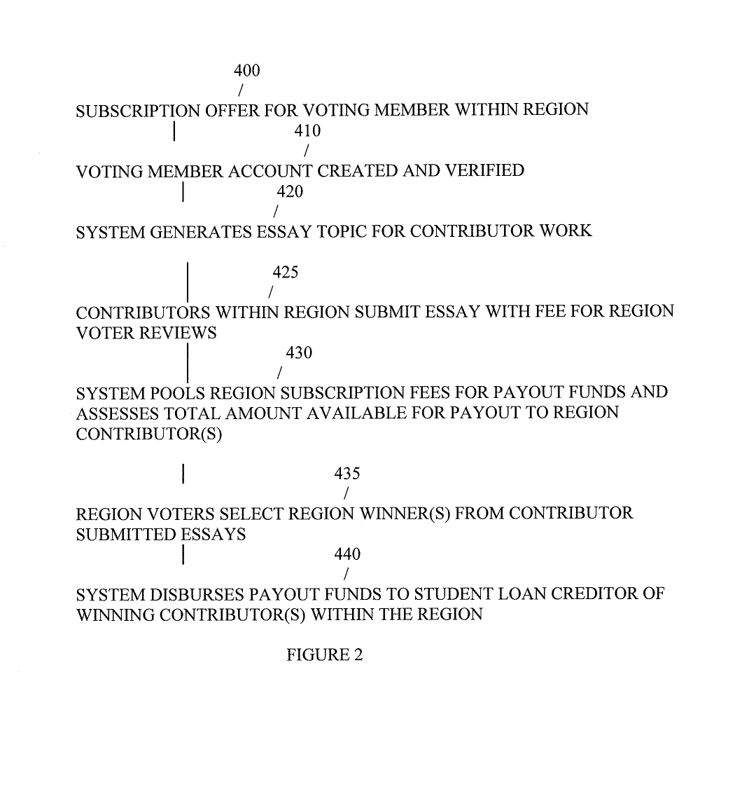

FIG. 2 presents a similar system as described in FIG. 1, but with the population of voting, and thus contributing, members limited to that within a specific geographic region (such as, for instance, the New England States, the Memphis metropolitan region, and the like). The system/on-line site would thus provide a subscription offer 400 to a prospective member within a specific region, defined, for example, as within a specific state, collection of states, ZIP Codes, etc. The system allows for each prospective member to input his or her location for such a purpose, if desired. Such a member may also choose to join within a region actually outside his or her specific location in order to collectively vote with and/or for certain individuals (as one possible reason for such a decision). In this respect, if exercised, the prospective member thus indicates acceptance thereof, completes an information display, and submits the proper subscription fee (through credit card, on-line payment service, etc., as is well known in this industry). Thereafter, the member is then considered a Voting Member and his or her account is created 410 (as well, the member's student loan information may also be verified; as above, such may be undertaken during contributing member account set-up as well). Within the timeframe at issue, then, the system will supply a generated essay topic 420 for the collection of regional voting members to decide whether or not to create his or her own responsive creative work (in this case, an essay; as noted previously, such a topic or other type of base consideration, may invite any type of creative work for review and judging by the voting members). Upon creation and submission thereof 425, the regional voting member becomes a regional contributing member (while still retaining the capacity and ability to vote during the timeframe at issue), providing an uploaded (or other manner of submission) copy of his or her work, a submission fee, and outstanding student loan indebtedness information (creditor name and address, total amount owed, etc.). Such payout proceeds are then calculated from the pooled regional voting member subscription fees for that time frame 430, just as described above in the broader system description. The system thus provides the calculated payout amount(s) for the time period at issue 430 and the regional voting members then cast their individual votes for regional contributor creative work submissions (here, an essay, related to the generated topic 420) 435. The selected winner(s) then receive notification of their selection in this respect and the system then disburses payout proceeds to the winner(s) student loan creditor for an amount determined by the payout proceed level from the pooled subscription fees 440.

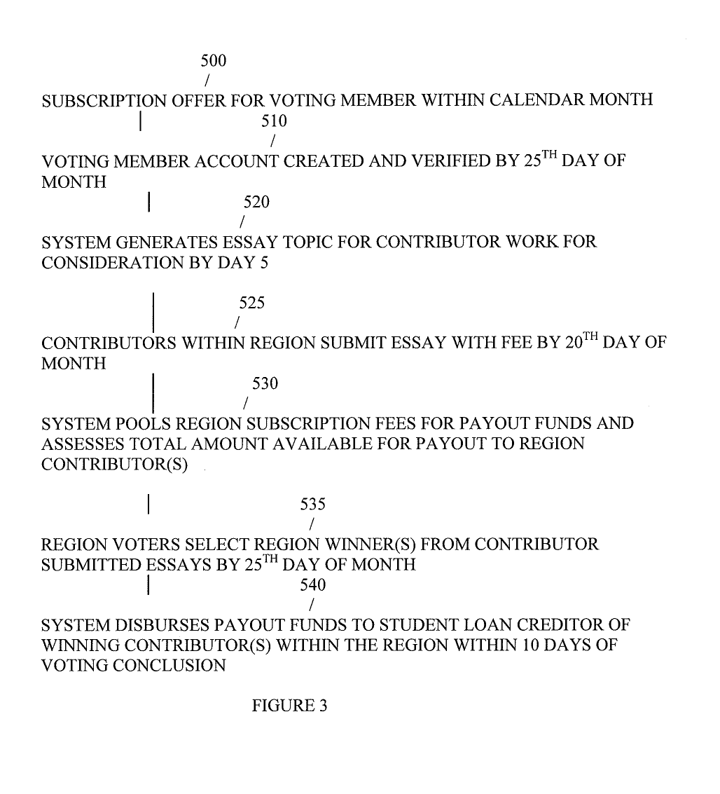

FIG. 3 thus presents a similar system as described in FIGS. 1 and 2, but with the population of voting, and thus contributing, members limited to that within a specific time frame, here within a calendar month (as noted above, such a time frame may actually cover any desired period, including every year, every six months, every 3 months, and the like). The system/on-line site would thus provide a subscription offer 500 to a prospective member for the month in question. The prospective voting member is given, in this situation, again, any date sets for such cut-offs may be implemented within the inventive system, until the 25^{th} day of the month to create his or her account 510 with the same information and possible student loan indebtedness disclosures as discussed above, provided for such a purpose. Basically, this allows the voting member(s) to subscribe up until the final date of voting, thus allowing for such an individual to review submissions and vote during that month, if desired. Thus, by the 5^{th} day of the month, the system generates a topic 520 (here, again, an essay topic) for the collection of voting members (subscribed during that specific month) to decide whether or not to create his or her own responsive creative work (here, again, an essay). Upon creation and submission thereof 525, the voting member becomes a contributing member (while still retaining the capacity and ability to vote during the month at issue), providing an uploaded (or other manner of submission) copy of his or her work, a submission fee, and outstanding student loan indebtedness information (creditor name and address, total amount owed, etc.). As above, such payout proceeds are then continuously calculated in a cumulative manner from the pooled voting member subscription fees for that month 430 until the voting member subscription period ends. The system thus provides the calculated payout amount(s) for the time period at issue 430 by the close of the 25^{th} day of the month and the voting members then cast their individual votes for contributor creative work submissions (here, an essay, related to the generated topic 520) 535. The selected winner(s) then receive notification of their selection in this respect and the system then disburses payout proceeds to the winner(s) student loan creditor for an amount determined by the payout proceed level from the pooled subscription fees 540.

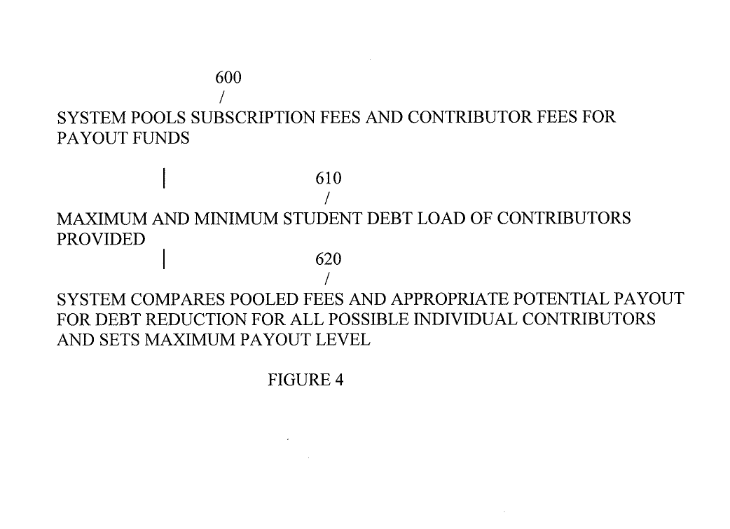

FIG. 4 thus delineates the manner of assessing the payout proceeds. This subsystem may be employed with any type of operation, whether broadly in terms of geography, time, etc., or narrow in that manner. Basically, the amounts of subscription fees and, alternatively, contributor fees, are pooled 600 within the time frame, geographical location, etc., at issue. Such an amount is then set for the total numbers of subscribers (voting members, at least, and, again, possibly the amounts provided by the contributor members with their submissions, from $0 to the entirety thereof) in order to compare that versus the student loan indebtedness levels of the contributing members for that region, time period, etc. Since the system does not payout to each and every contributor, the system must take the verified student loan information of each contributing member within the region, time period, etc., at issue in order to determine the range of maximum and minimum amount that could be subject to payout if any specific contributing member is chosen as the winner(s) 610. Certainly, it should be evident that the maximum and/or minimum may be above or below that of the collected pooled subscription funds for the time period, geographical region, etc., at issue, such that payout of a contributing member's student loan debt in its entirety may not be possible for that competition. In any event, the system assesses the overall situation automatically in order to internally compare the pool levels with the payout possibilities for the maximum payouts available 620. As noted previously, however, if the level for payout is set at a level that exceeds that of the minimum debt level of a potential winner, the system will not disburse any amount to such a person's student loan credit in excess of his or her debt. In such a situation, the system may determine that multiple winners may be possible and provide suitable disbursement as a first, second, and any other place, if such an outcome allows for greater payout without requiring the system to retain subscription fees funds from the pool thereof. This basic comparison method thus allows for a smooth and reliable manner of assessing such funds so the voting members will have trust that their subscription fees are handled specifically as they are intended and thus their votes will be counted for such a well-meaning purpose.

Such a system thus accords a contributor the potential to have a collective group of voting members decide that his or her scholarly article, essay, etc., merits not only consideration as a top creative work within a population, time frame, geographic region, etc., but also that such a meritorious scholarly piece deserves receipt of pooled monetary funds to help alleviate student (or other type of) debt load. The inventive system thus provides a collective approach to helping those in need, but with such potential payouts obtained through a merit-based operation which also permits significant submissions of scholarly and thoughtful items to not only the voting population at issue, but any others of interest. With the voting members involved doing so through a paid-in subscription situation, as well, such individuals have a vested interest to make the correct decision and further scholarly contributions, as well as aid their fellow contributors simultaneously.

It should be understood that various modifications within the scope of this invention can be made by one of ordinary skill in the art without departing from the spirit thereof. It is therefore wished that this invention be defined by the scope of the appended claims as broadly as the prior art will permit, and in view of the specification if need be.

What is claimed is:

1. An on-line decision-making system to allow for a specific population to select winners of a merit-based competition, said system including the method steps of
1) providing a subscription service in an on-line setting, wherein said service allows for a voting population to be developed from individuals that subscribe as member voters and a contributing population developed from said voting population that further contributes creative works to said service in response to an invitation from said service;
2) having said voting population individuals subscribe through at least paying a voter subscription fee to said service for a certain time period;
3) having said service generate a certain topic for which a contributor may create a creative work in relation to said topic such that said generated topic is provided by said service for a specific period of time for action to be undertaken by a plurality of members of said contributing population;
4) allowing for submissions of said creative works by said plurality of members of said contributing population, wherein each submission is made together with a contributor submission fee, wherein said contributor subscription fee is greater in amount per individual than said voter subscription fee, and wherein said creative works are submitted by said plurality of members of said contributing population for review by said voting population individuals for the time period for which each member of said available voting population are subscribers thereto;
5) having said voting population individuals select the most meritorious creative work within said time frame in relation to said generated topic after collective review thereof, wherein the most votes cast for a single creative work is sufficient for collective selection thereof for such a purpose; and
6) having said on-line service then generate a payout to the creditor of a winner (or winners) selected by said voting population, wherein said payout is assessed in relation to a) the amount said winner (or winners) currently have as student loan debt and b) to the overall monetary amount generated by the available subscription fees for said voting population and, optionally, at least a portion of the submission fees from said plurality of members of said contributing population within the time frame during which said merit-based competition is open for contributor submissions and thus during which such competitive creation selection is made by said voting population.

2. The system of claim 1 wherein said voting and contributing populations are limited in size to a specific geographic region.

3. The system of claim 2 wherein said contributor submissions are accepted from contributing population members located within the designated geographic region and all voting is undertaken by voting population members located within the designated geographic region.

4. The system of claim 1 wherein said subscription service is limited to a specific time period.

5. The system of claim 4 wherein said contributor submissions are permitted within said time period and all voting is undertaken with respect to such submissions solely within said time period.

5. The system of claim 1 wherein said payout is generated from a pool of funds solely derived from voting member subscription fees.

6. The system of claim 1 wherein said payout is generated from a pool of funds derived from voting member subscription fees and at least a portion of contributing member submission fees.

7. The system of claim 1 wherein said system further automatically assesses the amount of funds available from said voting member subscription fees and said contributing member submission fees and compares such an amount with the student loan debt levels of all contributing members to determine a payout level available amount for the potential winner or winners of said voting step.
